(19) United States
(12) Patent Application Publication
(10) Pub. No.: US 2026/0001022 A1
(43) Pub. Date: Jan. 1, 2026

(54) HONEYCOMB FILTER

(71) Applicant: NGK INSULATORS, LTD., Nagoya-Shi (JP)

(72) Inventors: Yudai KURIMOTO, Nagoya-Shi (JP); Katsunori TANAKA, Nagoya-Shi (JP)

(73) Assignee: NGK INSULATORS, LTD., Nagoya-Shi (JP)

(21) Appl. No.: 19/322,958

(22) Filed: Sep. 9, 2025

Related U.S. Application Data
(63) Continuation of application No. PCT/JP2023/012886, filed on Mar. 29, 2023.

(51) Int. Cl. B01D 46/24

(52) U.S. Cl. CPC B01D 46/247; B01D 46/2429; B01D 46/24491; B01D 46/2474; B01D 46/2482; B01D 46/2484; B01D 46/249; B01D 46/2494; B01D 2279/30

(57) ABSTRACT

A honeycomb filter includes a pillar-shaped honeycomb structure having a porous partition wall arranged to surround a plurality of cells and a plugging portion provided to plug either one end of the cell; wherein, in a section orthogonal to the extending direction of the cell of the honeycomb structure, the sectional shape of an inflow cell is octagonal or quadrangular, and the sectional shape of an outflow cell is quadrangular, except for the cell disposed in outermost circumference of the honeycomb structure, a cell density of the honeycomb structure is 49 to 70 cells/cm², a thickness of the partition wall is 0.152 to 0.198 mm, an opening diameter L1 of the inflow cell is 1.16 to 1.40 mm, an opening diameter L2 of the outflow cell is 0.82 to 1.08 mm, and a ratio (L1/L2) of the opening diameter L1 to the opening diameter L2 is 1.30 to 1.53.

### BACKGROUND OF THE INVENTION

### Technical Field

The present invention relates to a honeycomb filter. More specifically, the present invention relates to a honeycomb filter that is excellent in regeneration efficiency during continuous regeneration in which particulate matter that is trapped into a partition wall is burned and removed, and that can suppress an increase in pressure loss due to the deposition of ash.

### Background Art

Internal combustion engines are used as power sources in various industries. On the other hand, exhaust gas emitted by the internal combustion engine when burning includes particulate matter such as soot and ash. Hereinafter, the particulate matter may be referred to as “PM”. “PM” is an abbreviation for “Particulate Matter.” Regulations on the elimination of hazardous materials such as PM emitted from diesel engines are becoming stricter worldwide, and installation of the post-treatment system that purifies them is required.

In particular, a filter for removing PM emitted from a diesel engine is sometimes referred to as a Diesel Particulate Filter. Hereinafter, the diesel particulate filter is sometimes referred to as “DPF”. As such a DPF, for example, a honeycomb filter using a honeycomb structure is known (see, for example, Patent Documents 1 and 2).

Purification of exhaust gas by the honeycomb filter is performed as follows. First, the honeycomb filter is arranged such that its inflow end face side is located upstream side of an exhaust system from which exhaust gas is emitted. Exhaust gas flows into the inflow cell from the inflow end face side of the honeycomb filter. Exhaust gas flowing into the inflow cell passes through the porous partition wall, flows into the outflow cell, and is emitted from the outflow end face of the honeycomb filter.

When a DPF is used continuously to remove PM from exhaust gas, PM such as soot deposit inside the DPF, reducing purification efficiency and increasing pressure loss in the DPF. Therefore, for example, in purification devices using the DPF, a “regeneration process” is carried out in which PM such as soot deposited in the DPF is burned. If the soot is burned in a condition where a large amount of soot is deposited in the DPF, the temperature in the DPF becomes high, which may lead to damage to the DPF or the like. Therefore, it is essential to burn soot (in other words, the regeneration process) efficiently.

### CITATION LIST

### Patent Literature

Patent Document 1: JP-A-2004-000896

Patent Document 2: JP-A-2022-507651

### SUMMARY OF INVENTION

### Technical Problem

Examples of the regeneration process of the DPF include the following “forced regeneration” and “continuous regeneration”. In the case of the “forced regeneration”, fuel is intentionally injected into the DPF to raise the gas temperature inside the DPF to forcibly burn the soot deposited in the DPF. On the other hand, in the case of the “continuous regeneration”, NO in exhaust gas is converted into NO₂ by an oxidation catalyst, and this is used as an oxidizing agent to continuously burn the soot deposited in the DPF. In the continuous regeneration, the DPF is loaded with an oxidation catalyst for purifying exhaust gas, and regeneration can be continuously performed by the action of the catalyst. Here, as described above, the forced regeneration uses fuel for burning soot, which may lead to deterioration in fuel efficiency. The continuous regeneration requires the application of a relatively expensive noble metal as a catalyst.

Improvements in fuel efficiency have been more focused than in the past due to stricter regulations in recent years. For this reason, in the regeneration process of DPF as well, the continuous regeneration is attracting attention instead of the forced regeneration which causes deterioration in fuel efficiency, and improvement in regeneration efficiency in the continuous regeneration is expected. However, it is unclear which point of the DPF should be improved to improve regeneration efficiency in the continuous regeneration, so the current situation is that efforts are being made to improve the catalyst.

When the soot deposited in DPF is burned, ash is generated as a burnt residue of calcium (Ca) or the like. When such ash is deposited in DPF, pressure loss of the DPF increases, leading to deterioration in fuel efficiency. For example, conventionally, as a measure for suppressing an increase in pressure loss due to deposition of ash, a measure such as thinning wall by reducing the thickness of the partition wall has been taken. However, from the viewpoint of strength and heat capacity associated with thinning wall, it is not realistic to pursue only thinning wall, and it is desired to develop a technique for suppressing an increase in pressure loss due to deposition of ash by methods other than thinning wall.

The present invention has been made in view of the problems with the prior arts described above. The present invention provides a honeycomb filter that is excellent in regeneration efficiency during continuous regeneration and can suppress an increase in pressure loss due to the deposition of ash.

### Means for Solving the Problems

According to the present invention, a honeycomb filter described below is provided.
[1] A honeycomb filter including: a pillar-shaped honeycomb structure having a porous partition wall arranged so as to surround a plurality of cells which serve as fluid through channels extending from an inflow end face to an outflow end face; and a plugging portion provided so as to plug either one end on the inflow end face side or the outflow end face side of the cell, wherein
the cells having the plugging portion at ends on the outflow end face side and that are open on the inflow end face side are inflow cells,
the cells having the plugging portion at ends on the inflow end face side and that are open on the outflow end face side are outflow cells,
in a section orthogonal to the extending direction of the cell of the honeycomb structure, the sectional shape of the inflow cell is octagonal or quadrangular, and the sectional shape of the outflow cell is quadrangular, except for the cell disposed in outermost circumference of the honeycomb structure,
a cell density of the honeycomb structure is 49 to 70 cells/cm²,
a thickness of the partition wall is 0.152 mm or more,
an opening diameter L1 of the inflow cell is 1.16 to 1.40 mm,
an opening diameter L2 of the outflow cell is 0.82 to 1.08 mm, and
a ratio (L1/L2) of the opening diameter L1 to the opening diameter L2 is 1.30 to 1.53.
[2] The honeycomb filter according to [1], wherein a geometric surface area of the inflow cell is 1.23 to 1.50 mm²/mm³.
[3] The honeycomb filter according to [1] or [2], wherein a porosity of the partition wall is 35 to 65%.
[4]The honeycomb filter according to any one of [1] to [3], which is used as a diesel particulate filter.

### Advantageous Effects of Invention

The honeycomb filter of the present disclosure is excellent in regeneration efficiency during continuous regeneration in which PM such as soot is burned to remove, and can effectively suppress an increase in pressure loss due to the deposition of ash.

### BRIEF DESCRIPTION OF DRAWINGS

FIG. 1 This is a perspective view schematically showing an embodiment of a honeycomb filter according to the present invention as viewed from an inflow end face side.

FIG. 2 This is a plan view of the honeycomb filter shown in FIG. 1 as viewed from the inflow end face side.

FIG. 3 This is a plan view of the honeycomb filter shown in FIG. 1 as viewed from an outflow end face side.

FIG. 4 This is a sectional view schematically showing a section taken along the line A-A′ of FIG. 2.

FIG. 5 This is an enlarged plan view of a part of the inflow end face of the honeycomb filter shown in FIG. 2.

### DESCRIPTION OF EMBODIMENTS

The following will describe embodiments of the

present invention; however, the present invention is not limited to the following embodiments. Therefore, it should be understood that those created by adding changes, improvements or the like to the following embodiments, as appropriate, on the basis of the common knowledge of one skilled in the art without departing from the spirit of the present invention are also covered by the scope of the present invention.

### (1) Honeycomb Filter:

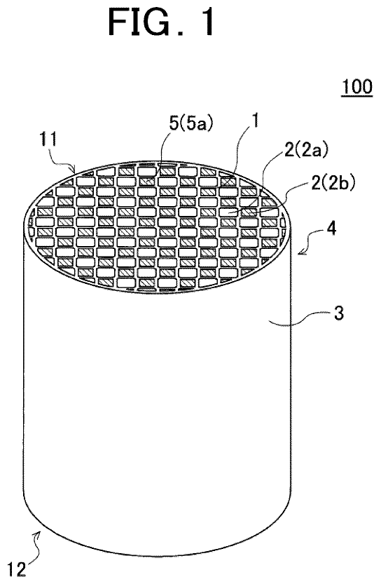

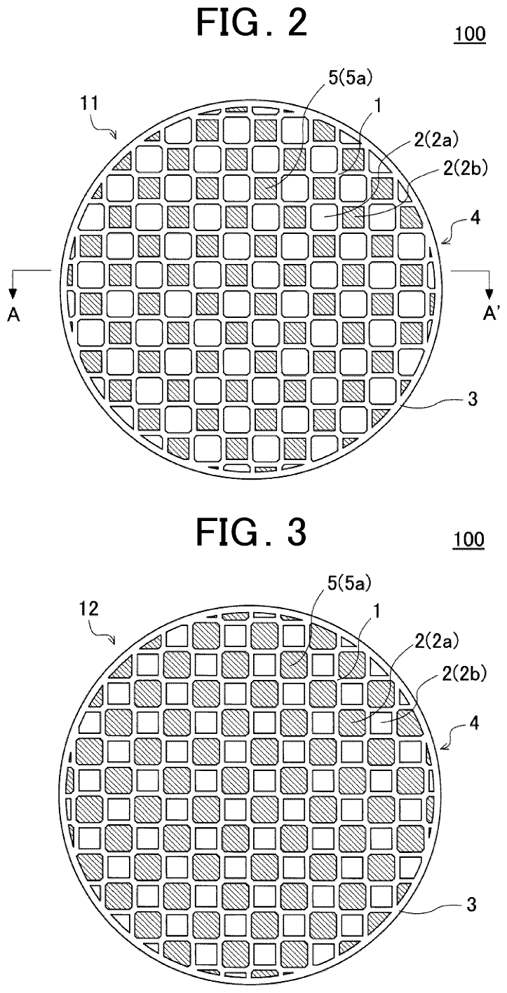

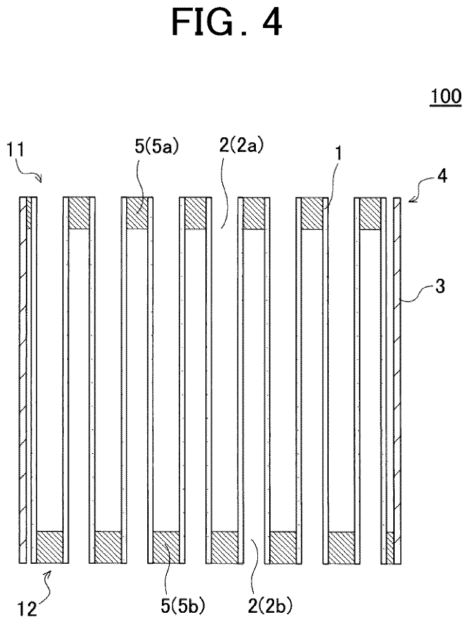

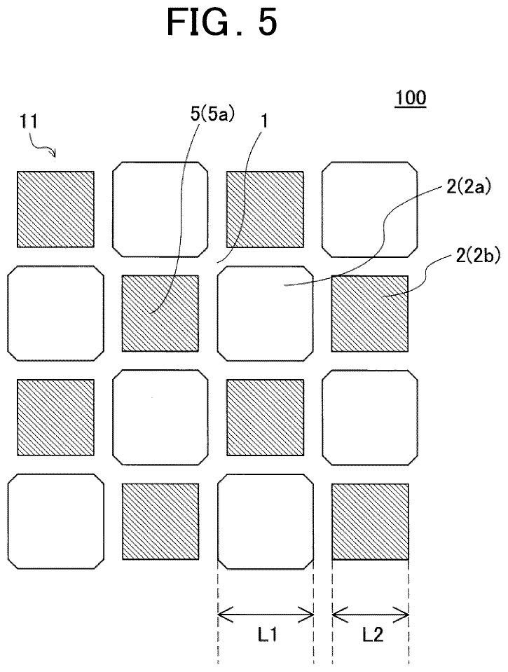

An embodiment of the honeycomb filter of the present invention is a honeycomb filter 100 as shown in FIGS. 1 to 5. Here, FIG. 1 is a perspective view schematically showing an embodiment of a honeycomb filter of the present invention as viewed from an inflow end face side. FIG. 2 is a plan view of the honeycomb filter shown in FIG. 1 as viewed from the inflow end face side, and FIG. 3 is a plan view of the honeycomb filter shown in FIG. 1 as viewed from an outflow end face side. FIG. 4 is a sectional view schematically showing a section taken along the line A-A′ of FIG. 2. FIG. 5 is an enlarged plan view of a part of the inflow end face of the honeycomb filter shown in FIG. 2.

As shown in FIGS. 1 to 5, the honeycomb filter 100 includes a honeycomb structure 4 and a plugging portion 5. The honeycomb structure 4 has a porous partition wall 1 arranged to surround a plurality of cells 2 which serve as fluid through channels extending from an inflow end face 11 to an outflow end face 12. The honeycomb structure 4 is a pillar-shaped structure having an inflow end face 11 and an outflow end face 12 as both end faces. In the present invention, the cell 2 refers to a space surrounded with the partition wall 1. The honeycomb structure 4 constituting the honeycomb filter 100 further includes a circumferential wall 3 disposed on an outer peripheral side surface thereof so as to encompass the partition wall 1.

The plugging portion 5 is provided either at the end on the inflow end face 11 side or the outflow end face 12 side of the cells 2 to plug the open end of the cells 2. The plugging portion 5 is a porous substance (that is, a porous body) composed of a porous material. In the honeycomb filter 100 shown in FIGS. 1 to 5, a predetermined cell 2 in which a plugging portion 5 (an inflow end face side plugging portion 5a) is provided at an end on the inflow end face 11 side, and a remaining cell 2 in which a plugging portion 5 (an outflow end face side plugging portion 5b) is provided at an end on the outflow end face 12 side are alternately arranged with the partition wall 1 therebetween.

Hereinafter, the cell 2 having the plugging portion 5 provided at the end on the inflow end face 11 side may be called “outflow cell 2b”. The cell 2 having the plugging portion 5 provided at the end on the outflow end face 12 side may be called “inflow cell 2a”.

In the honeycomb filter 100, in a section orthogonal to the extending direction of the cell 2 of the honeycomb structure 4, the sectional shape of the inflow cell 2a is octagonal or quadrangular, and the sectional shape of the outflow cell 2b is quadrangular, except for the cell 2 disposed in outermost circumference of the honeycomb structure 4. Hereinafter, a cell 2 in which the periphery of the cell 2 is surrounded only by the partition wall 1 may be referred to as a “complete cell”. On the other hand, when the honeycomb structure 4 is provided with a circumferential wall 3 on the outer peripheral side surface, a cell 2 disposed on outermost circumference of the honeycomb structure 4 (hereinafter, also simply referred to as “outermost circumference cell 2”) is the cell 2 surrounded by the partition wall 1 and the circumferential wall 3. In such an outermost circumference cell 2, a part of the periphery of the cell 2 is partitioned by the circumferential wall 3, and the cell 2 is an incomplete cell 2 in which a part of the complete cell is missing. The cell 2 in which the periphery of the cell 2 is surrounded by the partition wall 1 and the circumferential wall 3 may be referred to as an “incomplete cell”, and the incomplete cell is not included in the cell 2 constituting the inflow cell 2a and the outflow cell 2b described above. Therefore, unless otherwise specified, when the terms “inflow cell 2a” and “outflow cell 2b” are simply used, they refer to the complete cells, “inflow cell 2a” and “outflow cell 2b”.

The honeycomb filter 100 of the present embodiment has particularly major properties in the cell density and the thickness of the partition wall 1 and in the configuration of the inflow cell 2a and the outflow cell 2b of the honeycomb structure 4. In other words, in the honeycomb structure 4, the cell density of the cell 2 partitioned by the partition wall 1 is 49 to 70 cells/cm2. In addition, the thickness of the partition wall 1 constituting the honeycomb structure 4 is 0.152 mm or more. The upper limit of the thickness of the partition wall 1 is specified by the value of the cell density of the honeycomb structure 4 and the values of the opening diameter L1 of the inflow cell 2a and the opening diameter L2 of the outflow cell 2b, which will be described later.

In the honeycomb filter 100 of the present embodiment, the opening diameter L1 of the inflow cell 2a is 1.16 to 1.40 mm, and the opening diameter L2 of the outflow cell 2b is 0.82 to 1.08 mm. The ratio of the opening diameter L1 of the inflow cell 2a to the opening diameter L2 of the outflow cell 2b (L1/L2) is 1.30 to 1.53. Hereinafter, the “ratio of the opening diameter L1 of the inflow cell 2a to the opening diameter L2 of the outflow cell 2b (L1/L2)” may be referred to as the “opening diameter ratio (L1/L2)” of the outflow cell 2b and the inflow cell 2a.

The honeycomb filter 100 configured as described above is excellent in regeneration efficiency during continuous regeneration in which PM such as soot is burned and removed, and can effectively suppress an increase in pressure loss due to the deposition of ash. In particular, the honeycomb filter 100 can effectively suppress an increase in pressure loss during ash deposition while improving regeneration efficiency during continuous regeneration by setting the opening diameter ratio (L1/L2) of the outflow cell 2b and the inflow cell 2a to the above numerical range. For example, in a continuous regeneration, soot is burned by reacting with NO₂ on an oxidation catalyst (hereinafter, also simply referred to as “catalyst”) that is loaded on the partition wall 1. Therefore, by adjusting the opening diameter L1 and the opening diameter L2 so as to have the above-described opening diameter ratio (L1/L2), the geometric surface area of the inflow cell 2a becomes relatively large. With this configuration, the possibility of contact between the catalyst and the soot is increased, and regeneration efficiency during continuous regeneration can be improved. In addition, the oxidation catalyst loaded on the DPF can oxidize NOₓ (e.g., NO) emitted from the engine to NO₂, and in this case too, the oxidation function by the oxidation catalyst can be improved by increasing the geometric surface area of the inflow cell 2a. Therefore, the generation of NO₂, which functions as an oxidizing agent at the time of soot burning, is promoted, which contributes to the improvement of regeneration efficiency.

The reason for the increase in pressure loss during ash deposition is that the ash is deposited on the inner wall surface of the inflow cell 2a and on the end of the outflow end face 12 side, and the flow path through which the exhaust gas that has flowed into the inflow cell 2a can pass is narrowed. Therefore, the amount of ash deposited per one inflow cell 2a and the deposition thickness of the ash can be reduced by setting the cell density of the honeycomb structure 4 and the geometric surface area of the inflow cell 2a to appropriate values, and an increase in pressure loss caused by the deposition of the ash can be effectively suppressed. Hereinafter, the configurations of the honeycomb filter 100 of the present embodiment will be described more specifically.

The cell density of the honeycomb structure 4 is 49 to 70 cells/cm². When the cell density is less than 49 cells/cm², the opening diameter L1 of the inflow cell and the opening diameter L2 of the outflow cell are both increased, and it is difficult to sufficiently improve regeneration efficiency during continuous regeneration. On the other hand, when the cell density exceeds 70 cells/cm², for example, when the opening diameter L1 of the inflow cell is forcibly increased, the cell structure of the honeycomb structure 4 becomes distorted, and the isostatic strength of the honeycomb filter 100 decreases. The cell density is preferably 50 to 70 cells/cm², more preferably 50 to 69 cells/cm², and particularly preferably 52 to 68 cells/cm².

The thickness of the partition wall 1 is 0.152 mm or more. When the thickness of the partition wall 1 is less than 0.152 mm, the isostatic strength of the honeycomb filter 100 decreases. The upper limit of the thickness of the partition wall 1 is specified by the value of the cell density of the honeycomb structure 4 and the value of the opening diameter L1 of the inflow cell 2a and the value of the opening diameter L2 of the outflow cell 2b, as described above. For example, the thickness of the partition wall 1 is preferably 0.152 to 0.198 mm, more preferably 0.173 to 0.196 mm, and particularly preferably 0.178 to 0.193 mm. The thickness of the partition wall 1 can be measured with a scanning electron microscope or a microscope, for example.

The opening diameter L1 of the inflow cell 2a is 1.16 to 1.40 mm, and the opening diameter L2 of the outflow cell 2b is 0.82 to 1.08 mm. The opening diameter ratio (L1/L2) between the outflow cell 2b and the inflow cell 2a is 1.30 to 1.53. When the opening diameter L1 of the inflow cell 2a is less than 1.16 mm, the opening diameter L1 of the inflow cell 2a is too small, and the increase in pressure loss during ash deposition is increased. On the other hand, when the opening diameter L1 of the inflow cell 2a exceeds 1.40 mm, if the cell structure satisfies the opening diameter ratio (L1/L2) described above, the cell structure becomes distorted and the isostatic strength decreases. Further, even when the opening diameter L2 of the outflow cell 2b is outside the above numerical range, the above-described problems may occur when the cell structure satisfies the numerical range of the opening diameter L1 of the inflow cell 2a and the opening diameter ratio (L1/L2).

The opening diameter L1 of the inflow cell 2a may be 1.16 to 1.40 mm, but is preferably 1.17 to 1.39 mm. The opening diameter L2 of the outflow cell 2b may be 0.82 to 1.08 mm, but is preferably 0.83 to 1.08 mm. The opening diameter ratio (L1/L2) of the outflow cell 2b and the inflow cell 2a may be 1.30 to 1.53, but is preferably 1.32 to 1.49.

In addition, in a section orthogonal to the extending

direction of the cell 2 of the honeycomb structure 4, the sectional shape of the inflow cell 2a is octagonal or quadrangular, and the sectional shape of the outflow cell 2b is quadrangular, except for the cell 2 disposed in outermost circumference of the honeycomb structure 4. Hereinafter, for example, a “sectional shape of the cell 2” in a section orthogonal to the extending direction of the cell 2 of the honeycomb structure 4 may be referred to as a “sectional shape of the cell 2” or simply as a “shape of the cell 2”. In the sectional shape of the inflow cell 2a, the “octagonal” shall include an octagon, a shape in which at least one corner of the octagon is formed in a curved shape, and a shape in which at least one corner of the octagon is chamfer in a straight line. Similarly, in the sectional shapes of the inflow cell 2a and the outflow cell 2b, a “quadrangular” includes a quadrangle, a shape in which at least one corner of the quadrangle is formed in a curved shape, and a shape in which at least one corner of the quadrangle is chamfer in a straight line.

The honeycomb structure 4 preferably has repeating units in which inflow cells 2a having an octagonal or quadrangular sectional shape and outflow cells 2b having a quadrangular sectional shape are alternately arranged in a lattice shape with the partition wall 1 therebetween. The sectional shape of the outflow cell 2b is preferably square. The sectional shape of the inflow cell 2a is preferably an octagon with the four corners of the square chamfered or a square. For example, as shown in FIG. 5, when the plurality of cells 2 have a cell structure arranged along the left-right direction and the up-down direction of the page of FIG. 5, it is preferable that the inflow cells 2a and the outflow cells 2b are alternately arranged with the partition wall 1 therebetween in the arrangement of the cells in the respective directions. In the honeycomb filter 100, the inflow cell 2a preferably has one type of sectional shape in which the opening diameter L1 satisfies 1.16 to 1.40 mm, and the outflow cell 2b preferably has one type of sectional shape in which the opening diameter L2 satisfies 0.82 to 1.08 mm.

The opening diameter L1 of the inflow cell 2a is measured by the following method. In the opening shape of the inflow cell 2a, the distance between two opposite sides of the four sides adjacent to the outflow cell 2b across the partition wall 1 is defined as an “opening diameter L1 of the inflow cell 2a”. For the opening diameter L2 of the outflow cell 2b, in the opening shape of the outflow cell 2b, the distance between two opposite sides of the four sides of the quadrangle is defined as an “opening diameter L2 of the outflow cell 2b”. The opening diameter L1 and the opening diameter L2 can be measured using, for example, a scanning electron microscope or a microscope.

In the honeycomb filter 100, the geometric surface area of the inflow cell 2a is preferably 1.23 to 1.50 mm²/mm³, more preferably 1.25 to 1.49 mm²/mm³, and particularly preferably 1.27 to 1.48 mm²/mm³. The geometric surface area of the inflow cell 2a refers to the geometric surface area of the partition wall 1 disposed so as to surround the inflow cell 2a. The “geometric surface area” of the inflow cell 2a can be calculated as the total internal surface area (S: unit mm2) of the inflow cell 2a divided by the total volume (V: unit mm³) of the honeycomb structure 4 (S/V: unit mm²/mm³). Note that the total internal surface area(S) of the inflow cell 2a is the sum of the surface area of the partition wall 1 disposed so as to surround the inflow cell 2a (excluding the surface area where the outflow end face side plugging portion 5b is provided). The geometric surface area may be referred to as “GSA” or “geometric surface area GSA”, for example. The GSA is an abbreviation for “Geometric Surface Area”. When the geometric surface area of the inflow cell 2a is less than 1.23 mm²/mm³, it may not be possible to sufficiently improve regeneration efficiency during continuous regeneration. On the other hand, when the geometric surface area of the inflow cell 2a exceeds 1.50 mm²/mm³, the isostatic strength of the honeycomb filter 100 may decrease when the cell structure of the honeycomb structure 4 becomes distorted.

The porosity of the partition wall 1 is not particularly limited, but is preferably 35 to 65%, and more preferably 40 to 60%, for example. The porosity of the partition wall 1 is a value measured by mercury press-in method. The porosity of the partition wall 1 can be measured using Autopore 9500 (product name) manufactured by Micromeritics, for example. To measure the porosity, a part of the partition wall 1 is cut out from the honeycomb structure 4 to obtain a test piece, and the test piece thus obtained can be used. By setting the porosity of the partition wall 1 to the above-described numerical value, the honeycomb filter 100 can be particularly suitably used as a filter for purifying exhaust gas, particularly a diesel particulate filter (DPF).

The material of the partition wall 1 is not particularly limited. For example, the material of the partition wall 1 may include a material containing at least one selected from the group consisting of silicon carbide, cordierite, silicon-silicon carbide composite material, cordierite-silicon carbide composite material, silicon nitride, mullite, alumina, and aluminum titanate. The silicon-silicon carbide composite material is a composite material formed using silicon carbide as an aggregate and silicon as a bonding material. The cordierite-silicon carbide composite material is a composite material formed using silicon carbide as an aggregate and cordierite as a bonding material.

The circumferential wall 3 of the honeycomb structure 4 may be configured integrally with the partition wall 1 or may be a circumference coat layer formed by applying a circumferential coating material on the circumferential side of the partition wall 1. For example, although not shown, the circumferential coat layer can be provided on the circumferential side of the partition wall after the partition wall and the circumferential wall are integrally formed and then the formed circumferential wall is removed by a publicly known method, such as grinding, in a manufacturing process.

The shape of the honeycomb structure 4 is not particularly limited. The honeycomb structure 4 may be a pillar-shape in which the shapes of the inflow end face 11 and the outflow end face 12 are circular, elliptical, polygonal, or the like.

The size of the honeycomb structure 4, for example, the length from the inflow end face 11 to the outflow end face 12, and the size of the section orthogonal to the extending direction of the cells 2 of the honeycomb structure 4 are not particularly limited. Each size may be selected as appropriate such that optimum purification performance is obtained when the honeycomb filter 100 is used as a filter for purifying exhaust gas.

In the honeycomb filter 100, the partition wall 1 defining the plurality of cells 2 is preferably loaded with a catalyst for purifying exhaust gas. Loading the partition wall 1 with a catalyst refers to coating the catalyst onto the surface of the partition wall 1 and the inner walls of the pores formed in the partition wall 1. With this configuration, it is possible to turn CO, NOx, HC and the like in exhaust gas into harmless substances by catalytic reaction.

The catalyst loaded on the partition wall 1 is not particularly limited. For example, a catalyst containing a platinum group element and containing an oxide of at least one element among aluminum, zirconium, and cerium can be used.

### (2) Manufacturing Method of Honeycomb Filter

A method for manufacturing the honeycomb filter of the present invention is not particularly limited, and the honeycomb filter can be manufactured by the following method, for example. First, a plastic kneaded material for making a honeycomb filter is prepared. The kneaded material for making a honeycomb filter can be prepared by adding an additive such as a binder, pore former, and water, as appropriate, to a material selected from the above-described suitable materials of the partition wall as a raw material powder.

Next, the kneaded material thus obtained is subjected to extrusion to make a pillar-shaped honeycomb formed body having a partition wall defining a plurality of cells and a circumferential wall disposed so as to surround the partition wall. In the extrusion, a die in which a slit having an inverted shape of the honeycomb formed body to be formed is provided on the extruded surface of the kneaded material can be used as a die for extrusion. In particular, when manufacturing the honeycomb filter of the present invention, it is preferable to use, as a die for extrusion, a die in which slits for forming inflow cells and outflow cells each having a predetermined opening diameter in the honeycomb formed body to be extruded. Next, the obtained honeycomb formed body is dried by microwaves and hot air, for example.

Next, a plugging portion is provided at the open end of the cells of the dried honeycomb formed body. Specifically, for example, a plugging material containing raw materials for forming the plugging portion is first prepared. Next, a mask is provided on the inflow end face of the honeycomb formed body so as to cover the inflow cells. Next, the open ends of the outflow cells, which are not provided with a mask, on the inflow end face side of the honeycomb formed body are filled with the plugging material prepared in advance. Then, also in the outflow end face of the honeycomb formed body, the open ends of the inflow cells are filled with the plugging material in the same manner as above.

Next, the honeycomb formed body on which the plugging portion is disposed on one of open ends of the cell is fired to make a honeycomb filter. The firing temperature and the firing atmosphere differ according to the raw material, and those skilled in the art can select the firing temperature and the firing atmosphere that are the most suitable for the selected material.

### EXAMPLES

The following will describe in more detail the present invention by examples, but the present invention is not at all limited by the examples.

### Example 1

To 100 parts by mass of cordierite forming raw material, 2 parts by mass of pore former, 1 part by mass of dispersing medium, and 6 parts by mass of an organic binder were added, respectively, and mixed and kneaded to prepare a kneaded material. As the organic binder, methylcellulose was used. As the dispersing agent, potassium laurate was used. As the pore former, water absorptive polymer having the average particle diameter of 20 μm was used.

Next, the kneaded material was extruded using a die for making of a honeycomb formed body to obtain a honeycomb formed body having a round pillar shape as the entire shape. The cell shapes of the honeycomb formed body were octagonal and quadrangular, and the octagonal and quadrangular cells are arranged alternately with the partition wall therebetween.

Next, the honeycomb formed body was dried by a microwave dryer, and then was dried completely by a hot-air drier, and then both end faces of the honeycomb formed body were cut so as to have predetermined dimensions.

Next, a plugging material for forming the plugging portion was prepared. Specifically, water, a binder, and the like were added to the ceramic raw material to prepare a slurry-like plugging material. Thereafter, the plugging material was used to form a plugging portion on open ends of the predetermined cells on the inflow end face side and on open ends of the remaining cells on the outflow end face side of the dried honeycomb formed body. The plugging portion was formed in such a manner that cells having an octagonal cell shape became inflow cells and cells having a quadrangular cell shape became outflow cells.

Next, the honeycomb formed body on which the respective plugging portions were formed were degreased and fired to manufacture a honeycomb filter of Example 1.

The honeycomb filter of Example 1 had an end face diameter of 228.6 mm and a length in the extending direction of the cells of 184.2 mm. The honeycomb filter of Example 1 had a thickness of the partition wall of 0.185 mm and a cell density of 52 cells/cm². The results of the thickness of the partition wall and the cell density are shown in Table 1. In addition, the porosity of the partition wall of the honeycomb filter of Example 1 was 58%. The porosity of the partition wall was measured using Autopore 9500 (product name) produced by Micromeritics.

For the honeycomb filter of Example 1, the opening diameter L1 of the inflow cell and the opening diameter L2 of the outflow cell were measured. The results are shown in Table 1. In Table 1, the ratio of the opening diameter L1 of the inflow cell to the opening diameter L2 of the outflow cell is shown in the column of “Opening diameter ratio (L1/L2)”. In addition, in the honeycomb filter of Example 1, the geometric surface area of the inflow cell was 1.27 mm²/mm³.

TABLE 1

| | Partition | | Geometric surface | Opening | Opening | Opening |
|---|---|---|---|---|---|---|
| | wall | Cell | area of | diameter L1 of | diameter L2 of | diameter |
| | Thickness | density | Inflow cell | Inflow cell | Outflow cell | ratio |
| | (mm) | (cells/cm²) | (mm²/mm³) | (mm) | (mm) | (L1/L2) |
| Comparative | 0.191 | 47 | 1.20 | 1.44 | 1.12 | 1.29 |
| Example 1 | | | | | | |
| Example 1 | 0.185 | 52 | 1.27 | 1.37 | 1.05 | 1.30 |
| Example 2 | 0.193 | 54 | 1.29 | 1.33 | 1.01 | 1.32 |
| Example 3 | 0.191 | 54 | 1.31 | 1.37 | 0.97 | 1.41 |
| Example 4 | 0.178 | 66 | 1.46 | 1.25 | 0.85 | 1.47 |
| Example 5 | 0.173 | 67 | 1.48 | 1.27 | 0.83 | 1.53 |
| Example 6 | 0.191 | 62 | 1.38 | 1.24 | 0.92 | 1.35 |
| Example 7 | 0.183 | 68 | 1.45 | 1.25 | 0.85 | 1.47 |
| Example 8 | 0.152 | 62 | 1.41 | 1.26 | 0.97 | 1.30 |
| Example 9 | 0.188 | 50 | 1.25 | 1.39 | 1.07 | 1.30 |
| Example 10 | 0.193 | 49 | 1.23 | 1.40 | 1.08 | 1.30 |
| Example 11 | 0.198 | 68 | 1.44 | 1.17 | 0.85 | 1.38 |
| Example 12 | 0.196 | 70 | 1.46 | 1.16 | 0.84 | 1.38 |
| Example 13 | 0.178 | 69 | 1.49 | 1.23 | 0.83 | 1.48 |
| Example 14 | 0.178 | 70 | 1.50 | 1.22 | 0.82 | 1.49 |
| Comparative | 0.150 | 66 | 1.49 | 1.28 | 0.88 | 1.45 |
| Example 2 | | | | | | |
| Comparative | 0.196 | 67 | 1.41 | 1.15 | 0.91 | 1.26 |
| Example 3 | | | | | | |
| Comparative | 0.178 | 71 | 1.52 | 1.23 | 0.79 | 1.56 |
| Example 4 | | | | | | |

The honeycomb filter of Example 1 was measured for regeneration efficiency (%) during continuous regeneration and isostatic strength (MPa) in the following method. In addition, pressure loss evaluation during ash deposition was evaluated by the following method (hereinafter, referred to as “pressure loss evaluation during ash deposition”). The results are shown in Table 2.

### [Regeneration Efficiency During Continuous Regeneration (%)]

First, the partition wall of the honeycomb filter was loaded with an oxidation catalyst. The loaded amount of the catalyst was 10 g/L. Next, 3 g/L of soot was deposited on the partition wall of the honeycomb filter on which the catalyst was loaded as described above. In the honeycomb filter, a total of 23 g of soot was deposited. In this state, another honeycomb structure (catalyst carrier) loaded with an oxidation catalyst was disposed on the front stage of the honeycomb filter. Then, the high-temperature exhaust gas was flowed from the upstream side of the honeycomb structure of the front stage, and exhaust gas passed through the honeycomb structure of the front stage was vented from the inflow end face of the honeycomb filter, and continuous regeneration of the filter was performed. The exhaust gas shall be emitted from 6.7L diesel engine. The conditions for regeneration were that the gas temperature at the inflow end face was 350° C. and the gas ventilation time was 60 minutes. Thereafter, the honeycomb filter was removed from the device after continuous regeneration, and the amount of the soot remaining in the honeycomb filter was measured. The regeneration efficiency (%) during continuous regeneration was determined as the percentage (%) of the ratio obtained by dividing the mass of the soot reduced by the continuous regeneration by the mass of the soot initially deposited. When the regeneration efficiency (%) during continuous regeneration thus obtained exceeded the regeneration efficiency (50.8%) of the honeycomb filter of Comparative Example 1 to be described later, the filter was judged to have passed, and when it was lower than this, the filter was judged to have failed.

### [Pressure Loss Evaluation During Ash Deposition]

First, pressure loss of the honeycomb filter was measured, and the measured pressure loss was set as “initial pressure loss (kPa)”. Next, pressure loss was measured with a predetermined amount of soot and ash deposited on the partition wall of the honeycomb filter, and the measured pressure loss was set as “Pressure loss during ash deposition (kPa)”. When measuring pressure loss during ash deposition, the deposition amount of soot was 3 g/L and the deposition amount of ash was 60 g/L. Here, the deposition amount of soot and ash is the deposition amount (g) of soot and ash per unit volume (1L) of the honeycomb filter. Then, the value obtained by subtracting the “initial pressure loss (kPa)” from the “pressure loss during ash deposition (kPa)” was defined as the “pressure loss increase ΔP (kPa)” of the honeycomb filter to be evaluated. Further, the pressure loss increase ΔP of the honeycomb filter of Comparative Example 1 to be described later was used as a reference (base), and pressure loss increase rate (%) of the pressure loss evaluation during ash deposition was determined by Equation (1) below. In Equation (1) below, the pressure loss increase ΔP (kPa) of the honeycomb filter of Comparative Example 1 as a reference is defined as “reference pressure loss increase ΔPo”, and pressure loss increase ΔP (kPa) of the honeycomb filter to be evaluated is defined as “target pressure loss increase ΔP₁”. In the pressure loss evaluation during ash deposition, when the pressure loss increase ΔP was larger than that of the honeycomb filter of Comparative Example 1 as a reference, and pressure loss increase rate (%) was a positive value, the filter was judged to have failed.

$$Pressure loss increase rate ( \% ) = ( target pressure loss increase Δ {P}_{1} - reference pressure loss increase Δ {P}_{0} ) \times reference pressure loss increase Δ {P}_{0} \times 100 \% \qquad ( 1 )$$

### [Isostatic Strength (MPa)]

The isostatic strength was measured based on the isostatic breaking strength test specified in of the automotive standard (JASO Standard) M505-87 issued by Society of Automotive Engineers of Japan, Inc. The isostatic breaking strength test is a test in which a honeycomb filter is placed in a cylindrical container of rubber, and a lid is formed of an aluminum plate, and isotropic pressure compression is performed in water. The isostatic strength measured by the isostatic breaking strength test is indicated by the applied pressure value (MPa) at which the honeycomb filter breaks. When the isostatic strength was 1.0 MPa or more, it was judged to have passed, and when the isostatic strength was less than 1.0 MPa, it was evaluated as failed.

TABLE 2

| | Regeneration | Pressure | |
|---|---|---|---|
| | efficiency | loss | |
| | during | evaluation | |
| | Continuous | during | Isostatic |
| | regeneration | Ash | Strength |
| | (%) | deposition | (MPa) |
| Comparative Example 1 | 50.8 | Base | 3.0 |
| Example 1 | 54.1 | −7% | 3.1 |
| Example 2 | 54.6 | −4% | 3.2 |
| Example 3 | 54.8 | −16% | 2.7 |
| Example 4 | 59.0 | −24% | 2.5 |
| Example 5 | 60.0 | −28% | 1.3 |
| Example 6 | 57.5 | −8% | 2.7 |
| Example 7 | 60.8 | −21% | 2.4 |
| Example 8 | 58.8 | −24% | 1.1 |
| Example 9 | 51.7 | −4% | 3.2 |
| Example 10 | 51.1 | −1% | 3.3 |
| Example 11 | 59.4 | −4% | 2.8 |
| Example 12 | 60.5 | −5% | 2.6 |
| Example 13 | 61.2 | −24% | 1.5 |
| Example 14 | 62.0 | −22% | 1.4 |
| Comparative Example 2 | 59.2 | −34% | 0.6 |
| Comparative Example 3 | 58.8 | 16% | 3.5 |
| Comparative Example 4 | 62.0 | −25% | 0.9 |

### Examples 2 to 14 and Comparative Examples 1 to 4

A honeycomb filter was prepared in the same manner as in Example 1 except that the configuration of the honeycomb filter was changed as shown in Table 1.

For the honeycomb filters of Examples 2 to 14 and Comparative Examples 1 to 4, regeneration efficiency (%) during continuous regeneration and the isostatic strength (MPa) were measured in the same manner as in Example 1, and pressure loss evaluation during ash deposition was carried out. The results are shown in Table 2.

### Results

The honeycomb filters of Examples 1 to 14 showed good measurement results in both the regeneration efficiency (%) during continuous regeneration and the isostatic strength (MPa). In the honeycomb filters of Examples 1 to 14, also in the pressure loss evaluation during ash deposition, pressure loss increase AP was smaller than that of the honeycomb filter of Comparative Example 1 as a reference, and pressure loss increase rate (%) was negative.

On the other hand, in the honeycomb filter of Comparative Example 2, it was possible to improve regeneration efficiency (%) during continuous regeneration and to reduce pressure loss during ash deposition by reducing the thickness of the partition wall. However, since the thickness of the partition wall was excessively reduced, the isostatic strength was greatly reduced.

In the honeycomb filter of Comparative Example 3, the opening diameter L1 of the inflow cell was small, and the opening diameter ratio (L1/L2) was also as small as 1.26. Therefore, in the pressure loss evaluation during ash deposition of the honeycomb filter of Comparative Example 3, the ash deposited in the honeycomb filter blocked the inflow cells at the middle part rather than the latter part of the entire length, and the effective volume of the honeycomb filter was reduced, so that the pressure loss increase ΔP was larger than that of the honeycomb filter of Comparative Example 1.

In the honeycomb filter of Comparative Example 4, the cell density of the honeycomb structure was increased to 71 cells/cm². At such a cell density, if the opening diameter L1 of the inflow cell is ensured and the geometric surface area of the inflow cell is increased, the opening diameter L2 of the outflow cell must be decreased, causing the cell structure of the honeycomb structure to become distorted, resulting in a deterioration in isostatic strength.

### INDUSTRIAL APPLICABILITY

The honeycomb filter of the present invention can be used as a filter for removing PM emitted from a diesel engine.

### REFERENCE SIGNS LIST

1: Partition wall, 2: cell, 2a: inflow cell, 2b: outflow cell, 3: circumferential wall, 4: honeycomb structure, 5: plugging portion, 5a: inflow end face side plugging portion, 5b: outflow end face side plugging portion, 11: inflow end face, 12: outflow end face, 100: honeycomb filter, L1: opening diameter of inflow cell, L2: opening diameter of outflow cell.

1. A honeycomb filter comprising: a pillar-shaped honeycomb structure having a porous partition wall arranged so as to surround a plurality of cells which serve as fluid through channels extending from an inflow end face to an outflow end face; and a plugging portion provided so as to plug either one end on the inflow end face side or the outflow end face side of the cell; wherein
the cells having the plugging portion at ends on the outflow end face side and that are open on the inflow end face side are inflow cells,
the cells having the plugging portion at ends on the inflow end face side and that are open on the outflow end face side are outflow cells,
in a section orthogonal to the extending direction of the cell of the honeycomb structure, the sectional shape of the inflow cell is octagonal or quadrangular, and the sectional shape of the outflow cell is quadrangular, except for the cell disposed in outermost circumference of the honeycomb structure,
a cell density of the honeycomb structure is 49 to 70 cells/cm²,
a thickness of the partition wall is 0.152 to 0.198 mm,
an opening diameter L1 of the inflow cell is 1.16 to 1.40 mm,
an opening diameter L2 of the outflow cell is 0.82 to 1.08 mm, and
a ratio (L1/L2) of the opening diameter L1 to the opening diameter L2 is 1.30 to 1.53.

2. The honeycomb filter according to claim 1, wherein a geometric surface area of the inflow cell is 1.23 to 1.50 mm²/mm³.

3. The honeycomb filter according to claim 1, wherein a porosity of the partition wall is 35 to 65%.

4. The honeycomb filter according to claim 1, which is used as a diesel particulate filter.
